(19) United States
(12) Patent Application Publication
(10) Pub. No.: US 2024/0248871 A1
(43) Pub. Date: Jul. 25, 2024

(54) REMOTE MANAGEMENT OF WORK-LIFE BALANCE SCHEDULING

(71) Applicant: Zoom Video Communications, Inc., San Jose, CA (US)

(72) Inventor: Tania Sung-Yi Chen, Cupertino, CA (US)

(21) Appl. No.: 18/100,914

(22) Filed: Jan. 24, 2023

(51) Int. Cl. G06F 15/02; G06Q 10/1093

(52) U.S. Cl. CPC G06F 15/0266; G06Q 10/1093

(57) ABSTRACT

Systems and methods for remote management of work-life balance scheduling are provided. In some examples, a computing device may receive, from a client device, one or more remote management configurations, wherein the remote management configurations include one or more action s, selected from a plurality of actions, and one or more conditions. The computing device can receive, from a first calendar application, a first calendar event and a second calendar event and determining a period between the first calendar event and the second calendar event. The computing device may determine, based on the period, that a first condition corresponding to a first remote management configuration has been satisfied. The computing device can determine a planned action corresponding to the first remote management configuration and output a first command to cause the client device to schedule the planned action.

### FIELD

The present application generally relates to remote management of calendar applications, and more particularly relates to systems and methods for remote management of work-life balance scheduling.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 shows an example system that provides videoconferencing functionality to various client devices.

FIG. 2 shows an example system in which a video conference provider provides videoconferencing functionality to various client devices.

FIG. 3 shows an example of a system for remote management of work-life balance scheduling, according to some aspects of the present disclosure.

FIG. 4 shows an illustration of an example user interface that may be used in the system for remote management of work-life balance scheduling, according to some aspects of the present disclosure.

FIG. 5 shows an illustration of an example calendar used for remote management of work-life balance scheduling, according to some aspects of the present disclosure.

FIG. 6 shows a flowchart of an example method for remote management of work-life balance scheduling, according to some aspects of the present disclosure.

FIG. 7 shows an example computing device suitable for use in example systems or methods for remote management of work-life balance scheduling according to this disclosure.

### DETAILED DESCRIPTION

Examples are described herein in the context of systems and methods for remote management of work-life balance scheduling. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

Video conferencing is a prevalent medium for remote personal and business communications. In addition to video conferencing, modern video conference providers may include a variety of capabilities such as calendaring, planning, scheduling, organizing, collaborating, and chatting. With these capabilities follow increased demands on availability and productivity. As a result, a user of a video conferencing provider may have a densely populated calendar including planned video conferences, chats, meetings, appointments, and so on. The user with the densely populated calendar may experience difficulty scheduling breaks, meals, exercise, and other activities which may promote physical and mental health. For example, the user may forget to plan such activities or may not have time to plan them. In other words, a user striving to maintain a healthy balance between work commitments and non-work commitments (hereinafter “work-life balance”) may not find such balance promoted by a modern workday schedule that makes extensive use of the features of the video conferencing provider.

These difficulties can be addressed using example systems and methods for remote management of work-life balance scheduling. The following non-limiting example is provided to introduce certain embodiments. In this example, remote management of work-life balance scheduling may be enabled on a client device of a video conference provider. Upon enabling remote management of work-life balance scheduling, the client device may provide a landing page to allow selection of one or more actions from among various possible actions by a user or administrator of the video conference provider. The actions may include actions that can be included in reminders, notifications, or scheduled events, according to the remote management configuration. Example actions include “Take a Break,” “Eat a Meal”, or “Play a Game,” among many other possibilities. The landing page may also include a randomize action.

The client device may provide an option to select one or more conditions corresponding to selected actions. A condition may be the circumstances under which a particular action will be scheduled. For example, conditions may include instructions to identify schedule openings that exceed a particular duration. Or conditions may include instructions to set reminders, send notifications, or schedule activities under certain circumstances. For example, the conditions may specify that activities should be scheduled for the user at specified times, after meetings of a particular length, or according to another scheduling algorithm.

Following selections made on the client device, the client device may send, to the video conference provider, one or more remote management configurations. The remote management configurations may include one or more actions, selected from among the various actions, and one or more conditions, corresponding to the actions. For example, a remote management configuration may include indications to create a reminder of the “Take a Break” action for conditions including morning hours and a schedule opening exceeding 15 minutes. In another example, a remote management configuration may include indications to schedule the “Play a Game” action for conditions including afternoon hours and following video meetings longer than 2 hours.

The client device may include a calendar application. The calendar application may include one or more calendars. For instance, the user may utilize a calendar for workplace scheduling. The calendar application may include a user's scheduled video conferences, chat engagements, meetings, appointments, and other events. In some examples, the calendar application may import calendars from other third-party applications. The video conference provider may receive from the client device a calendar containing several scheduled events. For example, the calendar may include a first video conference, scheduled for 2 hours in the morning, and a second video conference, beginning 30 minutes after the first video conference, scheduled for 3 hours in the afternoon.

The video conference provider may identify a period between the first video conference and the second video conference. In this example, the video conference provider may identify a 30-minute period between the first meeting and the second meeting. The video conference provider may determine, based on the period, that a condition corresponding to a remote management configuration has been satisfied. For example, the video conference provider may determine that the condition associated with the “Take a Break” action, including morning hours and a schedule opening greater than 15 minutes, is satisfied by the 30-minute period identified between the first video conference and the second video conference. The video conference provider may determine a planned action associated with the satisfied condition. For example, the video conference provider may determine, from the remote management configuration, that the “Take a Break” action will be the planned action, corresponding to the condition.

The video conference provider may output a command to cause the client device to device to schedule the planned action. For example, the video conference provider may send a message to the client device including action information. The message may include a method of the application programming interface (“API”) of the client device for scheduling calendar events. The action information may include details about the event including names, labels, locations, dates, times, and among other elements. The client device may schedule the action according to the message and the action information. For example, the video conference provider may send a message to cause the creation of a calendar event corresponding to the “Play a Game” planned action. Alternatively, the video conference provider may send a message to cause creation of a reminder corresponding to the “Take a Break” planned action.

In some examples, the client device may include a marketplace application. For example, the marketplace application may allow for the installation of third-party applications on the client device. The third-party applications may correspond to one or more actions. For instance, an action may be “Exercise.” Upon generation of a remote management configuration associated with this action, the client device may provide access to the marketplace application. One example third-party application may be a fitness application that can be installed on the client device, which can correspond to the action “Exercise.” The client device may receive an indication of a selection of a third-party fitness application from among the third-party fitness applications in the marketplace application. The marketplace application may send an indication of the third-party fitness application marketplace selection to the video conference provider. The video conference provider may send a message specifying creation of a calendar event corresponding to the “Exercise” action including action information that contains additional data corresponding to the third-party fitness application selected in the marketplace application. The inclusion of the additional data may appear in the scheduled event or reminder, which can allow the client device to execute the selected third-party fitness application upon receipt of the reminder or other notification.

In some examples, upon receipt of a reminder from the client device, by the user, the client device may provide an option to send reminder configuration updates to the video conference provider. For example, a reminder may have a checkbox or button labeled “never remind me again at this time slot” or “remind me tomorrow.” The reminder configuration updates may correspond to reminder configurations included in the action preference settings. By using the button or checkbox, the client device may cause a command to be sent to the video conference provider to update the reminder configurations.

In some examples, the action preference settings may include a randomize setting selection. Upon receipt of a remote management configuration including the randomize action from the client device, the video conference provider may, responsive to the randomize action, select an action corresponding to a randomly selected action from among the one or more actions included in the remote management configurations whose conditions have occurred. For example, if the user has selected a “Play a Game” action and a “Take a Walk” action, and the conditions associated with each action have occurred, the video conference provider may randomly choose from among these two actions to determine the planned action.

In some examples, one or more action applications on the client device may be associated with the various available possible actions. For example, the “Take a Break” action may have an associated action application that includes a timer and music player. In another example, the “Play a Game” action may have an associated application that includes a simple game. The video conference provider may receive an indication that the planned action has begun. For example, during the period following the first video conference the client device may execute the reminder created by the video conference provider. The client device may send an indication to the video conference provider that the reminder has been executed. The video conference provider can then send a command including instructions to cause the timer and music player action application associated with the “Take a Break” action to execute on the client device.

These illustrative examples are given to introduce the reader to the general subject matter discussed herein and the disclosure is not limited to these examples. The following sections describe various additional non-limiting examples and examples of systems and methods for remote management of work-life balance scheduling.

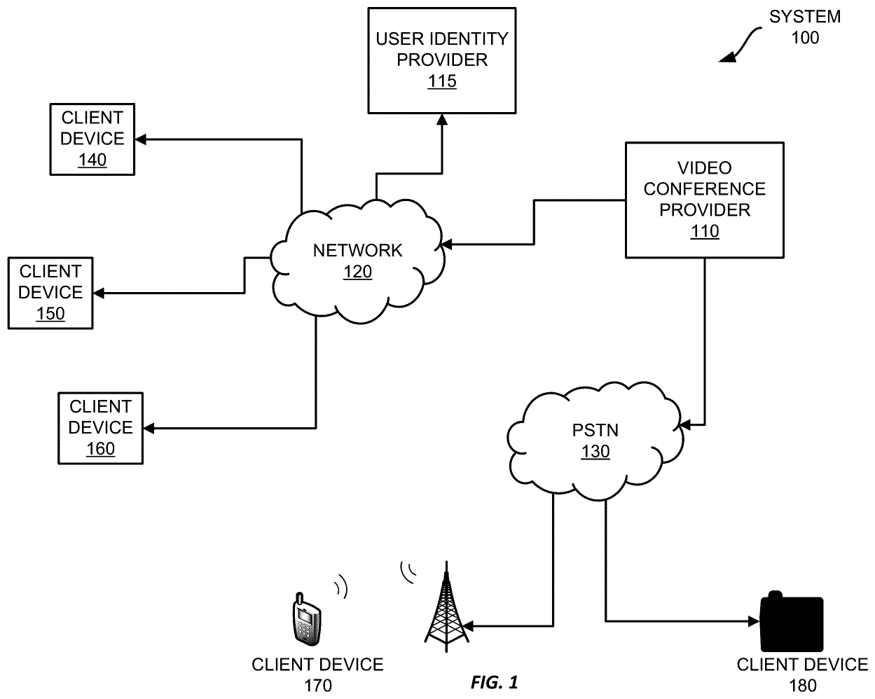

Referring now to FIG. 1, FIG. 1 shows an example system 100 that provides videoconferencing functionality to various client devices. The system 100 includes a video conference provider 110 that is connected to multiple communication networks 120, 130, through which various client devices 140-180 can participate in video conferences hosted by the chat and video conference provider 110. For example, the chat and video conference provider 110 can be located within a private network to provide video conferencing services to devices within the private network, or it can be connected to a public network, e.g., the internet, so it may be accessed by anyone. Some examples may even provide a hybrid model in which a video conference provider 110 may supply components to enable a private organization to host private internal video conferences or to connect its system to the chat and video conference provider 110 over a public network.

The system optionally also includes one or more user identity providers, e.g., user identity provider 115, which can provide user identity services to users of the client devices 140-160 and may authenticate user identities of one or more users to the chat and video conference provider 110. In this example, the user identity provider 115 is operated by a different entity than the chat and video conference provider 110, though in some examples, they may be the same entity.

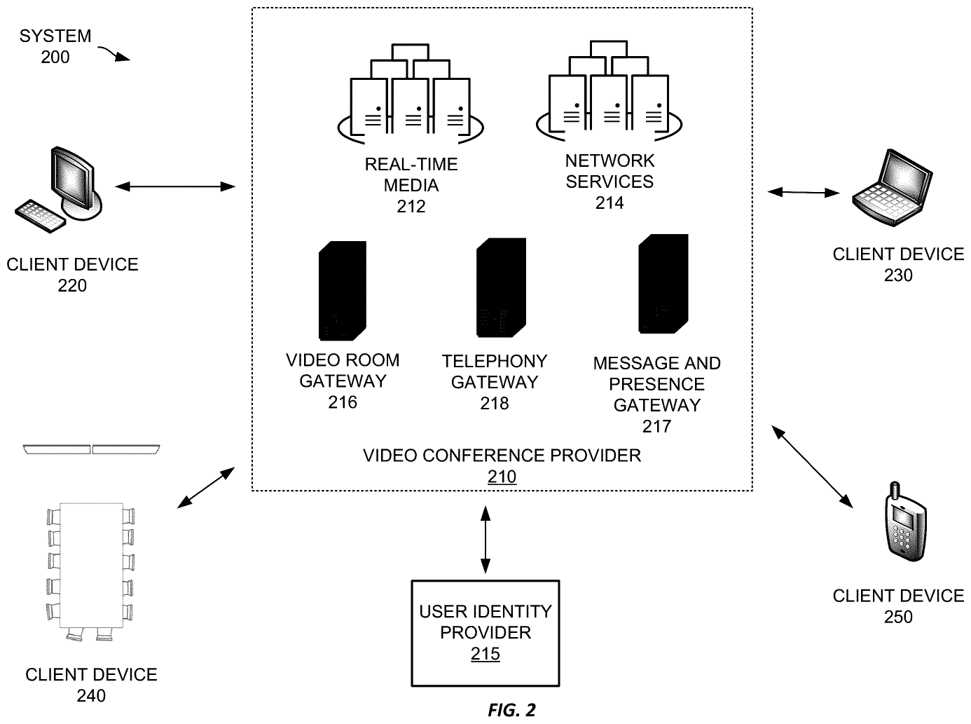

Video conference provider 110 allows clients to create videoconference meetings (or “meetings”) and invite others to participate in those meetings as well as perform other related functionality, such as recording the meetings, generating transcripts from meeting audio, generating summaries and translations from meeting audio, manage user functionality in the meetings, enable text messaging during the meetings, create and manage breakout rooms from the virtual meeting, etc. FIG. 2, described below, provides a more detailed description of the architecture and functionality of the chat and video conference provider 110. It should be understood that the term “meeting” encompasses the term “webinar” used herein.

Meetings in this example video conference provider 110 are provided in virtual rooms to which participants are connected. The room in this context is a construct provided by a server that provides a common point at which the various video and audio data is received before being multiplexed and provided to the various participants. While a “room” is the label for this concept in this disclosure, any suitable functionality that enables multiple participants to participate in a common videoconference may be used.

To create a meeting with the chat and video conference provider 110, a user may contact the chat and video conference provider 110 using a client device 140-180 and select an option to create a new meeting. Such an option may be provided in a webpage accessed by a client device 140-160 or client application executed by a client device 140-160. For telephony devices, the user may be presented with an audio menu that they may navigate by pressing numeric buttons on their telephony device. To create the meeting, the chat and video conference provider 110 may prompt the user for certain information, such as a date, time, and duration for the meeting, a number of participants, a type of encryption to use, whether the meeting is confidential or open to the public, etc. After receiving the various meeting settings, the chat and video conference provider may create a record for the meeting and generate a meeting identifier and, in some examples, a corresponding meeting password or passcode (or other authentication information), all of which meeting information is provided to the meeting host.

After receiving the meeting information, the user may distribute the meeting information to one or more users to invite them to the meeting. To begin the meeting at the scheduled time (or immediately, if the meeting was set for an immediate start), the host provides the meeting identifier and, if applicable, corresponding authentication information (e.g., a password or passcode). The video conference system then initiates the meeting and may admit users to the meeting. Depending on the options set for the meeting, the users may be admitted immediately upon providing the appropriate meeting identifier (and authentication information, as appropriate), even if the host has not yet arrived, or the users may be presented with information indicating that the meeting has not yet started or the host may be required to specifically admit one or more of the users.

During the meeting, the participants may employ their client devices 140-180 to capture audio or video information and stream that information to the chat and video conference provider 110. They also receive audio or video information from the chat and video conference provider 210, which is displayed by the respective client device 140 to enable the various users to participate in the meeting.

At the end of the meeting, the host may select an option to terminate the meeting, or it may terminate automatically at a scheduled end time or after a predetermined duration. When the meeting terminates, the various participants are disconnected from the meeting, and they will no longer receive audio or video streams for the meeting (and will stop transmitting audio or video streams). The chat and video conference provider 110 may also invalidate the meeting information, such as the meeting identifier or password/passcode.

To provide such functionality, one or more client devices 140-180 may communicate with the chat and video conference provider 110 using one or more communication networks, such as network 120 or the public switched telephone network (“PSTN”) 130. The client devices 140-180 may be any suitable computing or communications device that have audio or video capability. For example, client devices 140-160 may be conventional computing devices, such as desktop or laptop computers having processors and computer-readable media, connected to the chat and video conference provider 110 using the internet or other suitable computer network. Suitable networks include the internet, any local area network (“LAN”), metro area network (“MAN”), wide area network (“WAN”), cellular network (e.g., 3G, 4G, 4G LTE, 5G, etc.), or any combination of these. Other types of computing devices may be used instead or as well, such as tablets, smartphones, and dedicated video conferencing equipment. Each of these devices may provide both audio and video capabilities and may enable one or more users to participate in a video conference meeting hosted by the chat and video conference provider 110.

In addition to the computing devices discussed above, client devices 140-180 may also include one or more telephony devices, such as cellular telephones (e.g., cellular telephone 170), internet protocol (“IP”) phones (e.g., telephone 180), or conventional telephones. Such telephony devices may allow a user to make conventional telephone calls to other telephony devices using the PSTN, including the chat and video conference provider 110. It should be appreciated that certain computing devices may also provide telephony functionality and may operate as telephony devices. For example, smartphones typically provide cellular telephone capabilities and thus may operate as telephony devices in the example system 100 shown in FIG. 1. In addition, conventional computing devices may execute software to enable telephony functionality, which may allow the user to make and receive phone calls, e.g., using a headset and microphone. Such software may communicate with a PSTN gateway to route the call from a computer network to the PSTN. Thus, telephony devices encompass any devices that can making conventional telephone calls and is not limited solely to dedicated telephony devices like conventional telephones.

Referring again to client devices 140-160, these devices 140-160 contact the chat and video conference provider 110 using network 120 and may provide information to the chat and video conference provider 110 to access functionality provided by the chat and video conference provider 110, such as access to create new meetings or join existing meetings. To do so, the client devices 140-160 may provide user identification information, meeting identifiers, meeting passwords or passcodes, etc. In examples that employ a user identity provider 115, a client device, e.g., client devices 140-160, may operate in conjunction with a user identity provider 115 to provide user identification information or other user information to the chat and video conference provider 110.

A user identity provider 115 may be any entity trusted by the chat and video conference provider 110 that can help identify a user to the chat and video conference provider 110. For example, a trusted entity may be a server operated by a business or other organization and with whom the user has established their identity, such as an employer or trusted third-party. The user may sign into the user identity provider 115, such as by providing a username and password, to access their identity at the user identity provider 115. The identity, in this sense, is information established and maintained at the user identity provider 115 that can be used to identify a particular user, irrespective of the client device they may be using. An example of an identity may be an email account established at the user identity provider 115 by the user and secured by a password or additional security features, such as biometric authentication, two-factor authentication, etc. However, identities may be distinct from functionality such as email. For example, a health care provider may establish identities for its patients. And while such identities may have associated email accounts, the identity is distinct from those email accounts. Thus, a user's “identity” relates to a secure, verified set of information that is tied to a particular user and should be accessible only by that user. By accessing the identity, the associated user may then verify themselves to other computing devices or services, such as the chat and video conference provider 110.

When the user accesses the chat and video conference provider 110 using a client device, the chat and video conference provider 110 communicates with the user identity provider 115 using information provided by the user to verify the user's identity. For example, the user may provide a username or cryptographic signature associated with a user identity provider 115. The user identity provider 115 then either confirms the user's identity or denies the request. Based on this response, the chat and video conference provider 110 either provides or denies access to its services, respectively.

For telephony devices, e.g., client devices 170-180, the user may place a telephone call to the chat and video conference provider 110 to access video conference services. After the call is answered, the user may provide information regarding a video conference meeting, e.g., a meeting identifier (“ID”), a passcode or password, etc., to allow the telephony device to join the meeting and participate using audio devices of the telephony device, e.g., microphone(s) and speaker(s), even if video capabilities are not provided by the telephony device.

Because telephony devices typically have more limited functionality than conventional computing devices, they may be unable to provide certain information to the chat and video conference provider 110. For example, telephony devices may be unable to provide user identification information to identify the telephony device or the user to the chat and video conference provider 110. Thus, the chat and video conference provider 110 may provide more limited functionality to such telephony devices. For example, the user may be permitted to join a meeting after providing meeting information, e.g., a meeting identifier and passcode, but they may be identified only as an anonymous participant in the meeting. This may restrict their ability to interact with the meetings in some examples, such as by limiting their ability to speak in the meeting, hear or view certain content shared during the meeting, or access other meeting functionality, such as joining breakout rooms or engaging in text chat with other participants in the meeting.

It should be appreciated that users may choose to participate in meetings anonymously and decline to provide user identification information to the chat and video conference provider 110, even in cases where the user has an authenticated identity and employs a client device capable of identifying the user to the chat and video conference provider 110. The chat and video conference provider 110 may determine whether to allow such anonymous users to use services provided by the chat and video conference provider 110. Anonymous users, regardless of the reason for anonymity, may be restricted as discussed above with respect to users employing telephony devices, and in some cases may be prevented from accessing certain meetings or other services, or may be entirely prevented from accessing the chat and video conference provider 110.

Referring again to video conference provider 110, in some examples, it may allow client devices 140-160 to encrypt their respective video and audio streams to help improve privacy in their meetings. Encryption may be provided between the client devices 140-160 and the chat and video conference provider 110 or it may be provided in an end-to-end configuration where multimedia streams (e.g., audio or video streams) transmitted by the client devices 140-160 are not decrypted until they are received by another client device 140-160 participating in the meeting. Encryption may also be provided during only a portion of a communication, for example encryption may be used for otherwise unencrypted communications that cross international borders.

Client-to-server encryption may be used to secure the communications between the client devices 140-160 and the chat and video conference provider 110, while allowing the chat and video conference provider 110 to access the decrypted multimedia streams to perform certain processing, such as recording the meeting for the participants or generating transcripts of the meeting for the participants. End-to-end encryption may be used to keep the meeting entirely private to the participants without any worry about a video conference provider 110 having access to the substance of the meeting. Any suitable encryption methodology may be employed, including key-pair encryption of the streams. For example, to provide end-to-end encryption, the meeting host's client device may obtain public keys for each of the other client devices participating in the meeting and securely exchange a set of keys to encrypt and decrypt multimedia content transmitted during the meeting. Thus, the client devices 140-160 may securely communicate with each other during the meeting. Further, in some examples, certain types of encryption may be limited by the types of devices participating in the meeting. For example, telephony devices may lack the ability to encrypt and decrypt multimedia streams. Thus, while encrypting the multimedia streams may be desirable in many instances, it is not required as it may prevent some users from participating in a meeting.

By using the example system shown in FIG. 1, users can create and participate in meetings using their respective client devices 140-180 via the chat and video conference provider 110. Further, such a system enables users to use a wide variety of different client devices 140-180 from traditional standards-based video conferencing hardware to dedicated video conferencing equipment to laptop or desktop computers to handheld devices to legacy telephony devices. etc.

Referring now to FIG. 2, FIG. 2 shows an example system 200 in which a video conference provider 210 provides videoconferencing functionality to various client devices 220-250. The client devices 220-250 include two conventional computing devices 220-230, dedicated equipment for a video conference room 240, and a telephony device 250. Each client device 220-250 communicates with the chat and video conference provider 210 over a communications network, such as the internet for client devices 220-240 or the PSTN for client device 250, generally as described above with respect to FIG. 1. The chat and video conference provider 210 is also in communication with one or more user identity providers 215, which can authenticate various users to the chat and video conference provider 210 generally as described above with respect to FIG. 1.

In this example, the chat and video conference provider 210 employs multiple different servers (or groups of servers) to provide different Examples of video conference functionality, thereby enabling the various client devices to create and participate in video conference meetings. The chat and video conference provider 210 uses one or more real-time media servers 212, one or more network services servers 214, one or more video room gateways 216, one or more message and presence gateways 217, and one or more telephony gateways 218. Each of these servers 212-218 is connected to one or more communications networks to enable them to collectively provide access to and participation in one or more video conference meetings to the client devices 220-250.

The real-time media servers 212 provide multiplexed multimedia streams to meeting participants, such as the client devices 220-250 shown in FIG. 2. While video and audio streams typically originate at the respective client devices, they are transmitted from the client devices 220-250 to the chat and video conference provider 210 via one or more networks where they are received by the real-time media servers 212. The real-time media servers 212 determine which protocol is optimal based on, for example, proxy settings and the presence of firewalls, etc. For example, the client device might select among UDP, TCP, TLS, or HTTPS for audio and video and UDP for content screen sharing.

The real-time media servers 212 then multiplex the various video and audio streams based on the target client device and communicate multiplexed streams to each client device. For example, the real-time media servers 212 receive audio and video streams from client devices 220-240 and only an audio stream from client device 250. The real-time media servers 212 then multiplex the streams received from devices 230-250 and provide the multiplexed stream to client device 220. The real-time media servers 212 are adaptive, for example, reacting to real-time network and client changes, in how they provide these streams. For example, the real-time media servers 212 may monitor parameters such as a client's bandwidth CPU usage, memory and network I/O as well as network parameters such as packet loss, latency and jitter to determine how to modify the way in which streams are provided.

The client device 220 receives the stream, performs any decryption, decoding, and demultiplexing on the received streams, and then outputs the audio and video using the client device's video and audio devices. In this example, the real-time media servers do not multiplex client device 220's own video and audio feeds when transmitting streams to it. Instead, each client device 220-250 only receives multimedia streams from other client devices 220-250. For telephony devices that lack video capabilities, e.g., client device 250, the real-time media servers 212 only deliver multiplex audio streams. The client device 220 may receive multiple streams for a particular communication, allowing the client device 220 to switch between streams to provide a higher quality of service.

In addition to multiplexing multimedia streams, the real-time media servers 212 may also decrypt incoming multimedia stream in some examples. As discussed above, multimedia streams may be encrypted between the client devices 220-250 and the chat and video conference provider 210. In some such examples, the real-time media servers 212 may decrypt incoming multimedia streams, multiplex the multimedia streams appropriately for the various clients, and encrypt the multiplexed streams for transmission.

As mentioned above with respect to FIG. 1, the chat and video conference provider 210 may provide certain functionality with respect to unencrypted multimedia streams at a user's request. For example, the meeting host may be able to request that the meeting be recorded or that a transcript of the audio streams be prepared, which may then be performed by the real-time media servers 212 using the decrypted multimedia streams, or the recording or transcription functionality may be off-loaded to a dedicated server (or servers), e.g., cloud recording servers, for recording the audio and video streams. In some examples, the chat and video conference provider 210 may allow a meeting participant to notify it of inappropriate behavior or content in a meeting. Such a notification may trigger the real-time media servers to 212 record a portion of the meeting for review by the chat and video conference provider 210. Still other functionality may be implemented to take actions based on the decrypted multimedia streams at the chat and video conference provider, such as monitoring video or audio quality, adjusting or changing media encoding mechanisms, etc.

It should be appreciated that multiple real-time media servers 212 may be involved in communicating data for a single meeting and multimedia streams may be routed through multiple different real-time media servers 212. In addition, the various real-time media servers 212 may not be co-located, but instead may be located at multiple different geographic locations, which may enable high-quality communications between clients that are dispersed over wide geographic areas, such as being located in different countries or on different continents. Further, in some examples, one or more of these servers may be co-located on a client's premises, e.g., at a business or other organization. For example, different geographic regions may each have one or more real-time media servers 212 to enable client devices in the same geographic region to have a high-quality connection into the chat and video conference provider 210 via local servers 212 to send and receive multimedia streams, rather than connecting to a real-time media server located in a different country or on a different continent. The local real-time media servers 212 may then communicate with physically distant servers using high-speed network infrastructure, e.g., internet backbone network(s), that otherwise might not be directly available to client devices 220-250 themselves. Thus, routing multimedia streams may be distributed throughout the video conference system 210 and across many different real-time media servers 212.

Turning to the network services servers 214, these servers 214 provide administrative functionality to enable client devices to create or participate in meetings, send meeting invitations, create or manage user accounts or subscriptions, and other related functionality. Further, these servers may be configured to perform different functionalities or to operate at different levels of a hierarchy, e.g., for specific regions or localities, to manage portions of the chat and video conference provider under a supervisory set of servers. When a client device 220-250 accesses the chat and video conference provider 210, it will typically communicate with one or more network services servers 214 to access their account or to participate in a meeting.

When a client device 220-250 first contacts the chat and video conference provider 210 in this example, it is routed to a network services server 214. The client device may then provide access credentials for a user, e.g., a username and password or single sign-on credentials, to gain authenticated access to the chat and video conference provider 210. This process may involve the network services servers 214 contacting a user identity provider 215 to verify the provided credentials. Once the user's credentials have been accepted, the network services servers 214 may perform administrative functionality, like updating user account information, if the user has an identity with the chat and video conference provider 210, or scheduling a new meeting, by interacting with the network services servers 214.

In some examples, users may access the chat and video conference provider 210 anonymously. When communicating anonymously, a client device 220-250 may communicate with one or more network services servers 214 but only provide information to create or join a meeting, depending on what features the chat and video conference provider allows for anonymous users. For example, an anonymous user may access the chat and video conference provider using client device 220 and provide a meeting ID and passcode. The network services server 214 may use the meeting ID to identify an upcoming or on-going meeting and verify the passcode is correct for the meeting ID. After doing so, the network services server(s) 214 may then communicate information to the client device 220 to enable the client device 220 to join the meeting and communicate with appropriate real-time media servers 212.

In cases where a user wishes to schedule a meeting, the user (anonymous or authenticated) may select an option to schedule a new meeting and may then select various meeting options, such as the date and time for the meeting, the duration for the meeting, a type of encryption to be used, one or more users to invite, privacy controls (e.g., not allowing anonymous users, preventing screen sharing, manually authorize admission to the meeting, etc.), meeting recording options, etc. The network services servers 214 may then create and store a meeting record for the scheduled meeting. When the scheduled meeting time arrives (or within a threshold period of time in advance), the network services server(s) 214 may accept requests to join the meeting from various users.

To handle requests to join a meeting, the network services server(s) 214 may receive meeting information, such as a meeting ID and passcode, from one or more client devices 220-250. The network services server(s) 214 locate a meeting record corresponding to the provided meeting ID and then confirm whether the scheduled start time for the meeting has arrived, whether the meeting host has started the meeting, and whether the passcode matches the passcode in the meeting record. If the request is made by the host, the network services server(s) 214 activates the meeting and connects the host to a real-time media server 212 to enable the host to begin sending and receiving multimedia streams.

Once the host has started the meeting, subsequent users requesting access will be admitted to the meeting if the meeting record is located and the passcode matches the passcode supplied by the requesting client device 220-250. In some examples additional access controls may be used as well. But if the network services server(s) 214 determines to admit the requesting client device 220-250 to the meeting, the network services server 214 identifies a real-time media server 212 to handle multimedia streams to and from the requesting client device 220-250 and provides information to the client device 220-250 to connect to the identified real-time media server 212. Additional client devices 220-250 may be added to the meeting as they request access through the network services server(s) 214.

After joining a meeting, client devices will send and receive multimedia streams via the real-time media servers 212, but they may also communicate with the network services servers 214 as needed during meetings. For example, if the meeting host leaves the meeting, the network services server(s) 214 may appoint another user as the new meeting host and assign host administrative privileges to that user. Hosts may have administrative privileges to allow them to manage their meetings, such as by enabling or disabling screen sharing, muting or removing users from the meeting, assigning or moving users to the mainstage or a breakout room if present, recording meetings, etc. Such functionality may be managed by the network services server(s) 214.

For example, if a host wishes to remove a user from a meeting, they may identify the user and issue a command through a user interface on their client device. The command may be sent to a network services server 214, which may then disconnect the identified user from the corresponding real-time media server 212. If the host wishes to remove one or more participants from a meeting, such a command may also be handled by a network services server 214, which may terminate the authorization of the one or more participants for joining the meeting.

In addition to creating and administering on-going meetings, the network services server(s) 214 may also be responsible for closing and tearing-down meetings once they have completed. For example, the meeting host may issue a command to end an on-going meeting, which is sent to a network services server 214. The network services server 214 may then remove any remaining participants from the meeting, communicate with one or more real time media servers 212 to stop streaming audio and video for the meeting, and deactivate, e.g., by deleting a corresponding passcode for the meeting from the meeting record, or delete the meeting record(s) corresponding to the meeting. Thus, if a user later attempts to access the meeting, the network services server(s) 214 may deny the request.

Depending on the functionality provided by the chat and video conference provider, the network services server(s) 214 may provide additional functionality, such as by providing private meeting capabilities for organizations, special types of meetings (e.g., webinars), etc. Such functionality may be provided according to various examples of video conferencing providers according to this description.

Referring now to the video room gateway servers 216, these servers 216 provide an interface between dedicated video conferencing hardware, such as may be used in dedicated video conferencing rooms. Such video conferencing hardware may include one or more cameras and microphones and a computing device designed to receive video and audio streams from each of the cameras and microphones and connect with the chat and video conference provider 210. For example, the video conferencing hardware may be provided by the chat and video conference provider to one or more of its subscribers, which may provide access credentials to the video conferencing hardware to use to connect to the chat and video conference provider 210.

The video room gateway servers 216 provide specialized authentication and communication with the dedicated video conferencing hardware that may not be available to other client devices 220-230, 250. For example, the video conferencing hardware may register with the chat and video conference provider when it is first installed and the video room gateway may authenticate the video conferencing hardware using such registration as well as information provided to the video room gateway server(s) 216 when dedicated video conferencing hardware connects to it, such as device ID information, subscriber information, hardware capabilities, hardware version information etc. Upon receiving such information and authenticating the dedicated video conferencing hardware, the video room gateway server(s) 216 may interact with the network services servers 214 and real-time media servers 212 to allow the video conferencing hardware to create or join meetings hosted by the chat and video conference provider 210.

Referring now to the telephony gateway servers 218, these servers 218 enable and facilitate telephony devices' participation in meetings hosed by the chat and video conference provider 210. Because telephony devices communicate using the PSTN and not using computer networking protocols, such as TCP/IP, the telephony gateway servers 218 act as an interface that converts between the PSTN, and the networking system used by the chat and video conference provider 210.

For example, if a user uses a telephony device to connect to a meeting, they may dial a phone number corresponding to one of the chat and video conference provider's telephony gateway servers 218. The telephony gateway server 218 will answer the call and generate audio messages requesting information from the user, such as a meeting ID and passcode. The user may enter such information using buttons on the telephony device, e.g., by sending dual-tone multi-frequency (“DTMF”) audio signals to the telephony gateway server 218. The telephony gateway server 218 determines the numbers or letters entered by the user and provides the meeting ID and passcode information to the network services servers 214, along with a request to join or start the meeting, generally as described above. Once the telephony client device 250 has been accepted into a meeting, the telephony gateway server is instead joined to the meeting on the telephony device's behalf.

After joining the meeting, the telephony gateway server 218 receives an audio stream from the telephony device and provides it to the corresponding real-time media server 212 and receives audio streams from the real-time media server 212, decodes them, and provides the decoded audio to the telephony device. Thus, the telephony gateway servers 218 operate essentially as client devices, while the telephony device operates largely as an input/output device, e.g., a microphone and speaker, for the corresponding telephony gateway server 218, thereby enabling the user of the telephony device to participate in the meeting despite not using a computing device or video.

It should be appreciated that the components of the chat and video conference provider 210 discussed above are merely examples of such devices and an example architecture. Some video conference providers may provide more or less functionality than described above and may not separate functionality into different types of servers as discussed above. Instead, any suitable servers and network architectures may be used according to different examples.

In some embodiments, in addition to the video conferencing functionality describe above, the chat and video conference provider 210 (or the chat and video conference provider 110) may provide a chat functionality. Chat functionality may be implemented using a message and presence protocol and coordinated by way of a message and presence gateway 217. In such examples, the chat and video conference provider 210 may allow a user to create one or more chat channels where the user may exchange messages with other users (e.g., members) that have access to the chat channel(s). The messages may include text, image files, video files, or other files. In some examples, a chat channel may be “open,” meaning that any user may access the chat channel. In other examples, the chat channel may require that a user be granted permission to access the chat channel. The chat and video conference provider 210 may provide permission to a user and/or an owner of the chat channel may provide permission to the user. Furthermore, there may be any number of members permitted in the chat channel.

Similar to the formation of a meeting, a chat channel may be provided by a server where messages exchanged between members of the chat channel are received and then directed to respective client devices. For example, if the client devices 220-250 are part of the same chat channel, messages may be exchanged between the client devices 220-240 via the chat and video conference provider 210 in a manner similar to how a meeting is hosted by the chat and video conference provider 210.

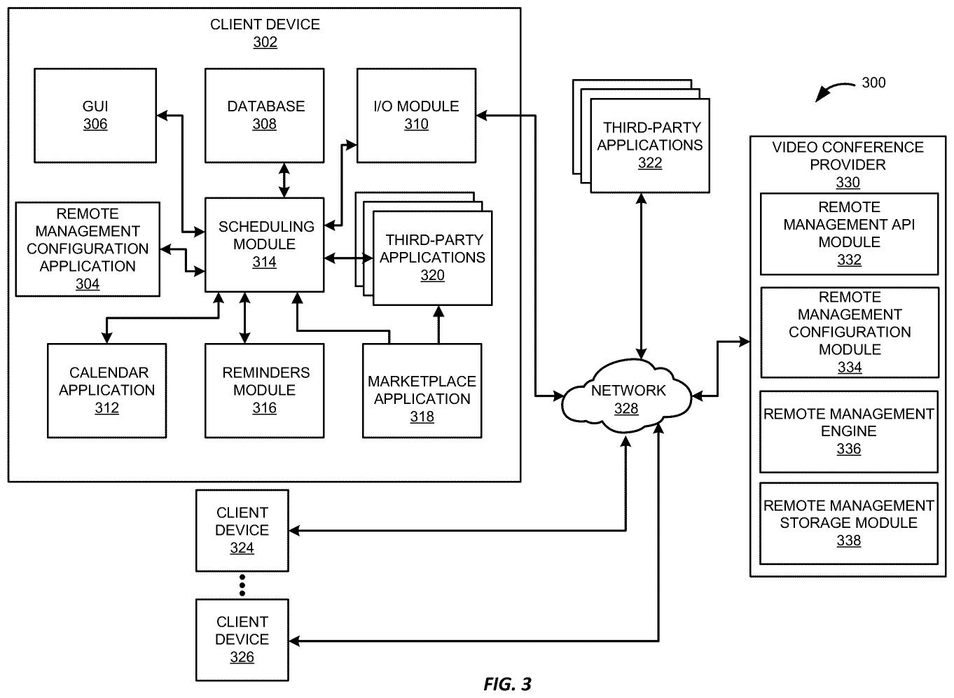

Referring now to FIG. 3, FIG. 3 shows an example of a system 300 for remote management of work-life balance scheduling, according to some aspects of the present disclosure. One or more client devices 302, 324, and 326 are communicatively coupled with a video conference provider 330. For example, the client devices 302, 324, and 326 may be coupled to the video conference provider over a network 328. The network 328 can include public networks, private networks, the Internet, or any other suitable combination of networked devices.

Turning now to the particular client device 302, the client device 302 may be a personal computer, laptop, smartphone, tablet, or similar device. The modules making up the client device 302 described herein may be implemented as hardware, software, or both. In some examples, some modules included in example system 300 may be hosted in other devices or remote servers. The client device may be controlled by way of a graphical user interface (GUI) 306. The GUI 306 may be displayed on a personal computer screen, smartphone screen, tablet screen, or the like.

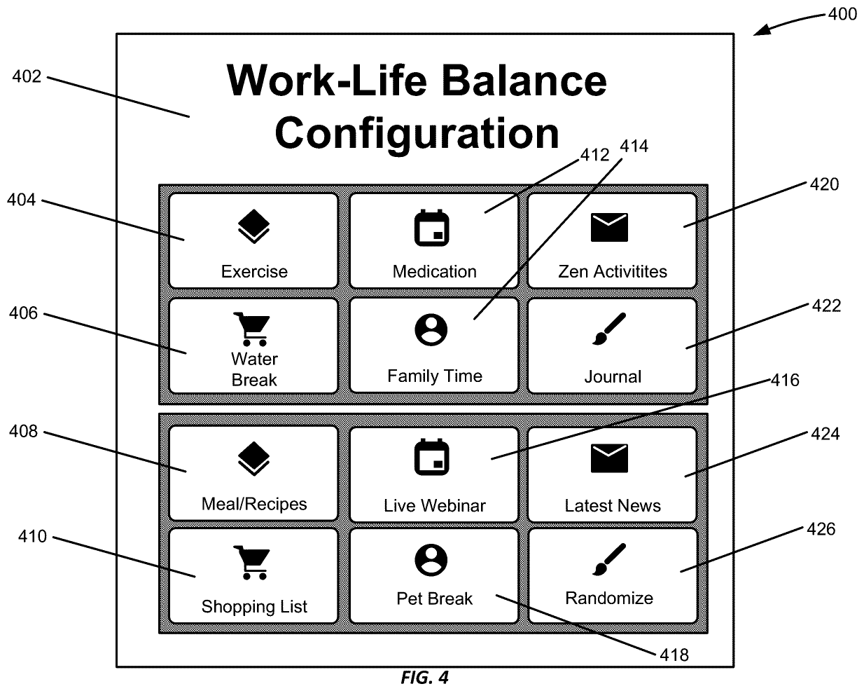

The client device 302 includes a remote management configuration application 304. The remote management configuration application 304 may provide a user interface to the GUI 306 for configuration and operation of remote management of work-life balance scheduling. An example user interface is described below in FIG. 4. The remote management configuration application 304 may be used to enable remote management of work-life balance scheduling and to generate remote management configurations. However, the configuration shown in FIG. 3 is only an example embodiment. For example, remote management of work-life balance scheduling can be enabled and configured using the client device 302 or by the video conference provider 330. For example, the conditions and actions of remote management of work-life balance can be scoped to organizations, groups, or individuals according to configurations generated by client devices 302, 324, and 326 or by the remote management configuration module 334 included in the video conference provider 330. Scope refers to the applicability of a particular remote management configuration. For example, a remote management configuration could be created using the remote management configuration application 304 of the client device 302 which may be scoped solely to the client device 302. In another example, a remote management configuration could be created using the remote management configuration module 334 included in the video conference provider 330 which may be scoped to client devices 302, 324, and 326, or some combination thereof. In another example, remote management configurations may be generated for client device 302 by another client device. For example, the administrator of an organization may generate remote management configurations which may then be deployed to the client devices of particular users, groups of users, or the video conference provider 330. The video conference provider 330 may include default remote management configurations that can be applied to organizations, groups, or individuals according to selections made by users or administrators.

A remote management configuration generated using the remote management configuration application 304 may include a selected action and one or more conditions, as well as other configurations. The remote management configuration may be in a machine-readable format, suitable for sending to the video conference provider 330. For example, the remote management configuration may be serialized JSON or XML, or another suitable format. The client device may send one or more remote management configurations to the video conference provider 330 using a data structure like an array or other suitable structure. For example, the remote management configurations may be an array wherein each element is an individual remote management configuration corresponding to a particular action, one or more conditions, and other related configuration data.

The remote management configuration may include a representation of the selected action. For example, the action in the remote management configuration may be a key corresponding to an entry in the database 308 or a unique text string. The remote management configuration may include one or more conditions associated with the action. For example, the remote management configuration may include a data structure that can represent conditions. Example conditions may include the minimum duration of the period between scheduled meetings, the minimum duration of the previous meeting or the following meeting, time of day, day of week, weather, as well as many other possibilities. Conditions may be represented using, for example, key/value pairs. For example, the condition “minimum duration of the period” may be identified by a key value that may correspond to the minimum duration in pre-determined units. The key value may correspond to an entry in the database 308, which contains additional data related to the condition. For example, the database entry may specify the pre-determined units for a condition. In some examples, the condition may be represented using a domain-specific language (“DSL”) or expression language (“EL”).

The remote management configuration may include additional configuration data. For example, the remote management configuration can include data relating to the particular action chosen. For instance, if a “Take a Walk” action is selected, the remote management configuration may include mapping data related the route of a walk, a hyperlink to a related resource, preferences about the length or speed of the walk, or any other data that may be used by the video conference provider 330 for generating the planned action. The data relating to the particular action may be selected or input using a GUI 306 or other suitable component for receiving user input. An example of a user interface that can be used for action selection and configuration is discussed below with respect to FIG. 4. For example, upon selecting the “Take a Walk” action on the GUI 306, a dialog box may be displayed that provides for the selection of additional configurations and preferences related to the “Take a Walk” action. For example, the additional configurations and preferences for the “Take a Walk” action may include specified time windows during which the action may be scheduled, user location data, weather requirements, or preferred walk locations. As another example, the additional configurations and preferences for a “Read the News” action could include specified news sources or subject preferences.

In some examples, the additional configurations and preferences can implicate user privacy concerns. In that case, the user interface can be configured to require explicit user consent before accepting certain configuration data. For instance, if the additional configurations and preferences include user location data, the user interface may present an additional dialog box or user interface element requiring the user to affirmatively consent to sending of this data to the video conference provider 330.

The database 308 may include data related to the remote management configurations. For example, an action included in a remote management configuration may correspond to one or more descriptions, images, customizations, and configuration parameters. For instance, the action “Take a Walk” may correspond to an introductory description and instructions for use, an image or map related to the walk, and details related to the configuration of the action. In another example, the conditions included in a remote management configuration may have related database entries. For example, the database 308 may include the allowed conditions for a particular action, configurations for specific actions, units of configurations, or representations of conditions using a DSL or EL. For instance, a “Go Shopping” action may correspond to a condition that uses geolocation to determine whether a market is nearby. Such a condition could be represented using an example EL as “distance({my.location}, {nearest.market})<10 miles.” The database 308 may also include additional configuration data. For example, the database 308 may store information related to the scope of remote management configurations. In some examples, the database 308 may store local copies of remote management configurations that mirror the remote management configurations stored in the remote management storage module 338.

The client device 302 includes an I/O module 310. The I/O module 310 may be used for communication over the network 328 with other client devices 324 and 326, third-party applications 322, and the video conference provider 330. The I/O module 310 may include a network device and one or more applications for network communications. For example, the I/O module 310 may include an application for interfacing with a web server. The application for interfacing with a web server may be used to exchange data with other devices using a web-based API. For example, the video conference provider 330 may provide a representational state transfer (“REST”) API that may be used to configure, update, and actuate the features of remote management of work-life balance scheduling. The I/O module may include other applications for network communications including, for example, application or socket communications or secure tunneling.

The client device includes a calendar application 312 in some examples. The calendar application 312 may also be provided by one or more electronic calendar providers that may be connected to the network 328 to enable various client devices 302, 324, and 326 to access electronic calendars for their respective users. The client device 302 also may have access to the user's own electronic calendar, such as by using an API or other messaging mechanism. In addition, the client device 302 is able to request calendar information from other meeting participants and provide meeting information to the other meeting participants or the video conference provider 330 to schedule a new meeting. It also can receive calendar information from the other participants, such as by accessing their electronic calendars directly, such as by accessing a corporate email or calendar application, obtaining information from the participants through manual input of free blocks of time, or by communicating with a third-party electronic calendar provider. The API of the calendar application 312 may be used to send data to the video conference provider 330 for use by the remote management engine 336 while evaluating conditions. The API of the calendar application 312 may also be used by the scheduling module 314 upon receipt of an indication from the video conference provider 330 to schedule an action.

The client device 302 includes a scheduling module 314. The remote management engine 336 may determine, based on data received from the calendar application 312, that an action should be scheduled according to a remote management configuration. The scheduling module 314 may receive, from the video conference provider 330, an indication of the action that should be scheduled via the I/O module 310. For example, the video conference provider 330 may send, to the scheduling module 314, an instruction to generate a calendar event at a particular date and time, a duration, text related to an action, and a hyperlink, among other possibilities. For instance, the scheduling module 314 may receive instructions to generate a calendar event for next Tuesday at 3 PM, for 15 minutes, containing text “Take a walk!” and a hyperlink to a web-based mapping application including a recommended route. The scheduling module 314 may send a command to the API of the calendar application 312, to create the event. In another example, the scheduling module 314 may receive instructions to generate a reminder for next Wednesday at 4 PM containing text “Cook a meal!” with a hyperlink to a web-based recipe.

The scheduling module 314 sends a command to the reminders module 316 to generate the reminder. The reminders module 316 may create reminders to cause events to occur on the client device 302. For example, the reminders module 316 may create a reminder to occur at 3 PM on Tuesday to create a GUI window that includes the text “Take a walk!” The GUI window may contain a “snooze” button that can dismiss the reminder for a specified period of time. Reminders may occur visually or audibly and may utilize, in addition to the functions of the client device 302, other media such as email, text/SMS messages, or mobile device notifications may be used for reminders.

The scheduling module 314 receives configuration information from the remote management configuration application 304. For example, the instructions to schedule events received from the video conference provider 330 may contain references to elements from a remote management configuration. The scheduling module 314 may request data corresponding to said references from the remote management configuration application 304, as well as the database 308. In some embodiments, the scheduling module 314 may receive a reference to the marketplace application 318. For example, the remote management configuration may include an action that may be related to one or more third-party applications 320 and 322. The scheduling module 314 may request a hyperlink from the marketplace application 318 corresponding to the action. For instance, the scheduling module 314 may receive instructions to generate a calendar event corresponding to the action “Zen Activity.” The instructions may include a reference to a subsection of the marketplace application 318 relating to mindfulness applications. The scheduling module 314 may request and receive, from the marketplace application 318, a hyperlink directing the client device 302 to the appropriate subsection of the marketplace application 318. Relatedly, the scheduling module 314 may also receive a reference to one or more third-party applications 320 and 322. Continuing with the previous example, the client device 302 or the video conference provider 330 may receive a marketplace selection from the marketplace application 318. For example, the selection may be for a particular mindfulness application. Subsequent instructions to the scheduling module 314 related to the action “Zen Activity” may now include marketplace selection information including, for example, a reference or hyperlink to the particular mindfulness application among the third-party applications 320 and 322.

The scheduling module 314 may, in some examples, generate customized subscriptions for the client device 302 associated with one or more remote management configurations. The subscriptions may be implemented, for instance, using webhooks. For example, upon creation or update of a remote management configuration by the remote management configuration application 304, the scheduling module 314 may create a webhook associated with the remote management configuration. The webhook may be a URL containing parameters that identify the client device 302, a user of the client device (e.g., a user email), one or more remote management configurations, or other parameters. The video conference provider 330, upon determining that an action should be scheduled, may send a web request to the URL of the webhook with data corresponding to the planned action. The data may be received at the URL of the webhook provided by the scheduling module 314. The scheduling module 314 can then cause the scheduling of the planned action corresponding to the condition(s) that have occurred.

The client device 302 includes one or more third-party applications 320. One or more third-party applications 322 may be hosted externally to the client device 302. For example, a third-party game may be installed on the client device 302 and a third-party recipe application may be a web application accessible from the client device 302. Some actions may include related third-party applications. For example, the action “Take a Walk” may have corresponding configuration data that includes a hyperlink to a third-party mapping application. The configuration data corresponding to some actions may be updated according to selections made in the marketplace application 318, which may subsequently be associated with scheduled events including hyperlinks or other references to third-party applications 320 and 322.

Turning next to the video conference provider 330, may be similar to the video conference provider 110, 210 described in FIGS. 1 and 2. The video conference provider 330 shown in example system 300 contains components that may implement the remote management of videoconferencing applications. The components of the video conference provider 330 may be implemented as hardware, software, or both. In some examples, some modules included in the video conference provider 330 may be hosted in other devices or remote servers. In some examples, the components of the video conference provider 330 may be long-running processes or daemons. In some examples, the components of the video conference provider 330 may be implemented as microservices. A microservice may be a small, functional submodule of a larger application that is communicatively coupled with other submodules of the application using, for example, an API. Implementing the components of the video conference provider 330 as microservices to handle the logic, monitoring, detection, and execution of remote management of videoconferencing applications may have a significant performance impact and lead to enhanced efficiency.

the video conference provider 330 includes a remote management API module 332. The remote management API module 332 may receive data from client devices 302, 324, and 326 or third-party applications 322. For example, the remote management API module 332 may be used to receive remote management configurations from client devices 302, 324, and 326. Or the remote management API module 332 may also be used to receive calendar data from the calendar application 312 of the client device 302. The remote management API module 332 may use REST, simple object access protocol (“SOAP”), Graph Query Language (“GraphQL”), remote method invocation, or other suitable implementation for receiving data from client devices 302, 324, and 326 or third-party applications 322.

The video conference provider 330 includes a remote management configuration module 334. The remote management configuration module 334 may receive instructions to generate remote management configurations from the remote management API module 332. For example, the remote management configuration module 334 may be used to create remote management configurations that are scoped to specific users, groups, or organizations. The remote management configuration module 334 may be an alternative to creating remote management configurations using a client device 302. For example, an organization administrator may disable the creation of remote management configurations by client devices 302, 324, and 326 for business or compliance reasons but still retain the ability to generate remote management configurations using the remote management configuration module 334.

The video conference provider 330 includes a remote management engine 336. The remote management engine 336 may identify, based on data receive from the client device 302, one or more periods between one or more calendar events. The remote management engine 336 can determine, based on data received from the client device 302, a planned action according to remote management configurations stored in the remote management storage module 338 upon the occurrence of the corresponding one or more conditions. For example, the remote management engine 336 may determine that a “Take a Walk” action should be scheduled as a reminder based on a first calendar event longer than 2 hours, a period between events longer than 15 minutes, and the end of the first calendar event being in the afternoon. The remote management engine 336 may then output a command to cause the client device to schedule the planned action in the calendar. For example, the command may include data indicating actions to be performed on the client device 302 in accordance with the planned action. The data may take the form of method calls from a programming language, remote procedure calls, or a similar invocation scheme. The remote management engine 336 may send the command to the scheduling module 314 of the client device 302 for execution.

The remote management engine 336 may include a component that periodically checks for the occurrence of conditions included in remote management configurations. For instance, the remote management engine 336 may iterate over all conditions and check for the occurrence of those conditions. In another example, the remote management engine 336 may include an event-based framework, in which conditions containing particular dates, times, or other elements are checked for occurrence upon certain triggering events. For instance, all remote management configurations containing a condition that relates to Tuesday at 3 PM may be checked for occurrence when the date and time become Tuesday at 3 PM. Other remote management engine 336 implementations are possible as well.

The remote management engine 336 may receive an indication that the planned action scheduled by the scheduling module 314 has begun. The video conference provider 330 may output instructions to the client device 302 corresponding to one or more action applications associated with the planned action. For example, if an exercise action included in a scheduled calendar event begins on the calendar application 312 of the client device 302, the remote management engine 336 may output instructions to cause execution of an exercise action application on the client device 302. The exercise action application may supplement the exercise action. For example, the exercise action application may include facilities for selection of an exercise, logging of completed exercises, weather-related functionality, or other functions. In some embodiments, the exercise action application may receive configuration data from the corresponding remote management configuration. The remote management configuration, including configuration and settings for the associated action application, may be selected or input using the GUI 306 or other suitable component for receiving user input. An example of a user interface that can be used for action selection and configuration is discussed below with respect to FIG. 4. For example, the remote management configuration for the exercise action application may include default or preferred types of exercise for a given user. As another example, the remote management configuration for a particular action may include a user's subscribed channels or services corresponding to the action application(s) that are associated with that action.

The video conference provider 330 includes a remote management storage module 338. The video conference provider 330 may receive remote management configurations from one or more client devices 302, 324, and 326 or from the remote management configuration module 334. The video conference provider 330 may store the remote management configurations for use by the remote management engine 336 as described above. The remote management storage module 338 may store the remote management configurations in any suitable format. For example, the remote management storage module 338 may include a document-based database or a relational structured query language (“SQL”) database for storing the remote management configurations. In some embodiments, both the client device 302 and the remote management storage module 338 may utilize the database 308. In some examples, the remote management storage module 338 may provide the remote management configurations to the remote management configuration application 304 of the client device 302. The client device 302 may then provide the capability to update or delete remote management configurations using the GUI 306.

As described above, the client device 302 can include a number of components, but those skilled in the art will recognize that other configurations are possible. For example, in some embodiments the database 308 may be an external database accessed over the network 328. In some embodiments, the marketplace application 318 may be a web application accessed through a web browser on the client device 302 over the network 328. Other embodiments are also possible.

One or more modules making up the client device 302 and the video conference provider 330 described herein may include implementations of artificial intelligence or machine learning technologies (not shown) for remote management of work-life balance scheduling. For example, a machine learning model may be trained using training data derived from a plurality of users using a plurality of client devices. The machine learning model may be a part of the video conference provider 330 or another communicatively coupled server and may send outputs in a suitable format to the client devices or other components of the video conference provider 330. In one example, a machine learning model may be trained using historical data relating the performance or non-performance of planned actions, as discussed below with respect to the random suggestion action button 426. The trained machine learning model can then be used by the remote management engine 336 to select actions when the randomize action is selected, according to the historical data. For example, the machine learning model may determine that a user prefers to exercise under certain conditions and prefers Zen activities under other conditions and select planned actions accordingly.

The machine learning model may be an ensemble of machine learning technologies. The machine learning model may include neural networks, gradient boosted machines, random forests, generalized linear models, and reinforcement models. However, any suitable machine learning model may be used according to different examples, such as deep convolutional neural networks (“CNNs”); a residual neural network (“Resnet”), or a recurrent neural network, e.g. long short-term memory (“LSTM”) models or gated recurrent units (“GRUs”) models, a three-dimensional CNN (“3DCNN”), a dynamic time warping (“DTW”) technique, a hidden Markov model (“HMM”), a support vector machine (SVM), decision tree, random forest, etc., or combinations of one or more of such techniques—e.g., CNN-HMM or MCNN (Multi-Scale Convolutional Neural Network). Further, some examples may employ adversarial networks, such as generative adversarial networks (“GANs”), or may employ autoencoders (“AEs”) in conjunction with machine learning models, such as AEGANs or variational AEGANS (“VAEGANs”).

Referring now to FIG. 4, FIG. 4 shows an illustration of an example user interface 400 that may be used in the system 300 for remote management of work-life balance scheduling, according to some aspects of the present disclosure. For example, the example user interface 400 may be displayed and operated on the GUI 306 of the client device 302. The example user interface 400 may be a landing page that is displayed, for example, when remote management of work-life balance scheduling is enabled on the client device 302.

The example user interface 400 may include a title 402. The example user interface 400 may include various actions that may be selected. Actions may have a corresponding button, for example, button 404. The action indicated on the button may correspond to a scheduled event, reminder, notification, or other future plan to perform that action. When a button is selected, the client device 302 may provide an additional user interface for selection of conditions and additional configuration data relating to the selected action. The action, conditions, and additional configuration data may be included in a remote management configuration.

Descriptions of the actions depicted in the example user interface 400 will be given. It should be appreciated that the actions shown in example user interface 400 are just examples and that other actions and user interface configurations are possible. Example actions may include disengaging from the client device 302, breathing exercises, standing up, changing to a different desk setting, changing tasks, drinking water, stretching exercises, taking bathroom breaks, taking medication, taking walks, spending time with pets, meditating, singing karaoke, watering plants, cooking a meal, biking, reading inspiration materials, closing eyes, napping, stretching, changing desk configurations, taking a break, performing yoga or similar exercise routines, running on a treadmill, spending time with family, performing Zen activities, journaling, cooking a recipe, attending a live webinar, reading, listening to, or viewing news, shopping, or playing a game.

An exercise action is selected with an exercise action button 404. The exercise action may correspond to a scheduled event, reminder, notification, or other future plan to perform physical exercise. For example, a planned action that may result from selection of the exercise action is a reminder at the conclusion of a 2-hour video meeting that includes the text “Go on a 1-mile jog!” along with a hyperlink to a mapping application that specifies a jogging route. The exercise action may be included in a remote management configuration. When the exercise action button 404 is selected, the client device 302 may provide an additional user interface for selection of conditions and additional configuration data. The remote management configuration may include additional configuration data including type of exercise (e.g., running, lifting weights, etc.), a location, a duration, weather data, or a duration range, among other possible data. For instance, the additional user interface may allow for the selection of ‘exercise type (e.g., bicycling, yoga, aerobics, etc.) or duration. The client device 302 may also allow for the designation of certain additional configuration data as default or preferred settings. The default or preferred settings may be preselected in subsequent encounters with the additional user interface. In some examples, the exercise action may be associated with an exercise action application. For example, the exercise action application may display instructions for breathing exercises, launch a simple timer-based breathing exercise, or display instructions for arm exercise with a music or beat. In another example, the exercise action application may display, on the client device 302, instructions for a suggested simple, low risk exercise. The client device 302 may provide an option to select a different exercise.

Some example exercise action applications may include goal tracking. For example, an exercise action application could track exercise participation over a period of time and include user interface features for setting, tracking, updating, and canceling exercise goals. Exercise participation may be tracked using user interface elements including, for example, “Jog Completed” or “Jog Skipped” buttons to indicate whether progress towards goals is being made.

Another example action is a water break action that is selected with a water break action button 406. The water break action may correspond to a scheduled event, reminder, notification, or other future plan to drink water. For example, a planned action that may result from selection of the drink water action is a 15-minute scheduled calendar event at the conclusion of a 3-hour video meeting between the hours of 9 AM and 12 PM that includes the text “Take a water break.” The water break action may be included in a remote management configuration. When the water break action button 406 is selected, the client device 302 may provide an additional user interface for selection of conditions and additional configuration data. The remote management configuration may include additional configuration data including duration of the break and location for the water break among other possible data. In some examples, the water break action may be associated with a water break action application. For example, the water break action application may include an interactive check mark corresponding to an indication that water was consumed. The water break action application may include other forms of indicating that water was consumed during the water break.

Example actions can include a meal/recipes action that may be selected with a meal/recipes action button 408. The meal/recipes action may correspond to a scheduled event, reminder, notification, or other future plan to eat a meal, prepare a recipe, order lunch, or prepare a smoothie. For example, a planned action that may result from the selection of the meal/recipes action is a 45-minute scheduled calendar event during a 1-hour period following a 3-hour video meeting after 12 PM that includes the text “Cook a meal.” The meal/recipes action may be included in a remote management configuration. When the meal/recipes action button 408 is selected, the client device 302 may provide an additional user interface for selection of conditions and additional configuration data. The remote management configuration may include additional configuration data including web-based resources for recipes, meal types, and ingredient specifications among other possible data. In some examples, the meal/recipes action may be associated with a meal/recipes action application. For example, the meal/recipes action application may display recipe suggestions corresponding to ingredient lists included in the remote management configuration.

A further example action may be a shopping list action that may be selected with a shopping list action button 410. The shopping list action may correspond to a scheduled event, reminder, notification, or other future plan to prepare a shopping list. For example, a planned action that may result from the selection of the shopping list action is a reminder during any 15-minute period that includes the text “Prepare a shopping list.” The shopping list action may be included in a remote management configuration. When the shopping list action button 410 is selected, the client device 302 may provide an additional user interface for selection of conditions and additional configuration data. The remote management configuration may include additional configuration data including web-based resources for preparing shopping lists, vendor selections, and locations among other possible data. In some examples, the shopping list action may be associated with a shopping list action application. For example, the shopping list action application may include a text editor for generation of a shopping list.

Yet another example action may be a medication action that may be selected with a medication action button 412. The medication action may correspond to a scheduled event, reminder, notification, or other future plan to consume a medication. For example, a planned action that may result from the selection of the medication action is a reminder during any 15-minute period that includes the text “Don't forget to take your medication!” The medication action may be included in a remote management configuration. When the medication action button 412 is selected, the client device 302 may provide an additional user interface for selection of conditions and additional configuration data. The remote management configuration may include additional configuration data including lists of medications, dosages, and times of day corresponding to the list of medications, among other possible data. In some examples, the medication action may be associated with a medication action application. For example, the medication application may include an interactive check box that may be displayed on the client device 302 for indicating that the medication action is completed.

Still another example action may be a family time action that may be selected with a family time action button 414. The family time action may correspond to a scheduled event, reminder, notification, or other future plan to spend time with one or more family members. For example, a planned action that may result from the selection of the family time action is a reminder during a period 30 minutes or greater following a meeting ending after 6 PM that includes the text “Spend time with your kids!” The family time action may be included in a remote management configuration. When the family time action button 414 is selected, the client device 302 may provide an additional user interface for selection of conditions and additional configuration data. The remote management configuration may include additional configuration data including lists of family members and family activities, among other possible data. In some examples, the family time action may be associated with a family time action application. For example, the family time action application may include an interactive check box that may be displayed on the client device 302 for indicating that time has been spent with a particular family member.

Another example action may be a live webinar action that may be selected with a live webinar action button 416. The live webinar action may correspond to a scheduled event, reminder, notification, or other future plan to join a webinar. For example, a planned action that may result from the selection of the live webinar action is a reminder during any 1 hour or greater period on Mondays that includes the text “Consider joining the training seminar today.” The live webinar action may be included in a remote management configuration. When the live webinar action button 416 is selected, the client device 302 may provide an additional user interface for selection of conditions and additional configuration data. The remote management configuration may include additional configuration data including hyperlinks to webinars, topics, and participants, among other possible data. In some examples, the live webinar action may be associated with a live webinar action application. For example, the live webinar action application may include list of currently available live webinars that may be displayed on the client device 302.

Another example action may be a pet break action that may be selected with a pet break action button 418. The pet break action may correspond to a scheduled event, reminder, notification, or other future plan to spend time with pets. For example, a planned action that may result from the selection of the pet break action is a reminder during any 15-minute period that includes the text “Pet the cat!” The pet break action may be included in a remote management configuration. When the pet break action button 418 is selected, the client device 302 may provide an additional user interface for selection of conditions and additional configuration data. The remote management configuration may include additional configuration data including lists of pets and times of day corresponding particular pets, among other possible data. In some examples, the pet break action may be associated with a pet break action application. For example, the pet break action application may include an interactive check box that may be displayed on the client device 302 for indicating that time has been spent with a particular pet.

Another example action may be a Zen activities action that may be selected with a Zen activities action button 420. The Zen activities action may correspond to a scheduled event, reminder, notification, or other future plan to perform one or more Zen activities. Zen activities may include meditation, breathing exercises, and mindfulness exercises, among others. For example, a planned action that may result from the selection of the Zen activities action is a reminder during any 30 minute or less period during mornings on Wednesdays that includes the text “Stop for a meditation break!” The Zen activities action may be included in a remote management configuration. When the Zen activities action button 420 is selected, the client device 302 may provide an additional user interface for selection of conditions and additional configuration data. The remote management configuration may include additional configuration data including lists of activities, corresponding weather requirements, and times of day corresponding to the particular activities, among other possible data. In some examples, the Zen activities action may be associated with a Zen activities action application. For example, the Zen activities action application may a mediation module that may include, for example, a dark screen, depiction of candlelight, or soothing sounds, among other possibilities that may be implemented by the client device 302.

Some example Zen activities action applications may include goal tracking. For example, a Zen activities action application could track activity participation over a period of time and include user interface features for setting, tracking, updating, and canceling Zen activity goals. Activity participation may be tracked using user interface elements including, for example, “Achieved” or “Skipped” buttons to indicate whether progress towards goals is being made.

Another example action may be a journal action that may be selected with a journal action button 422. The journal action may correspond to a scheduled event, reminder, notification, or other future plan to write in a journal. For example, a planned action that may result from the selection of the journal action is a reminder during any 20-minute periods following meetings 4 hours long or less that includes the text “Write a page in your journal!” The journal action may be included in a remote management configuration. When the journal action button 422 is selected, the client device 302 may provide an additional user interface for selection of conditions and additional configuration data. The remote management configuration may include additional configuration data including journal topics and journaling locations, among other possible data. In some examples, the journal action may be associated with a journal action application. For example, the journal action application may include a text editor application may be used on the client device 302 for journaling. The journal action application may include journal templates. Journal templates may be portions of or example journal entries upon which users may construct journal entries. Journal entries may assist users selecting the journal action in selecting journal topics, creating structured journal entries, or achieving journaling goals.

Some example journal action applications may include goal tracking. For example, a journal action application could track journaling participation over a period of time and include user interface features for setting, tracking, updating, and canceling journaling goals. Journaling may be tracked using user interface elements including, for example, “Journal Entry Written” or “Skipped” buttons to indicate whether progress towards goals is being made.

Another example action may be a latest news action that may be selected with a latest news action button 424. The latest news action may correspond to a scheduled event, reminder, notification, or other future plan to read, view, or listen to news. For example, a planned action that may result from the selection of the latest news action is a reminder during any 15-minute period that includes the text “Consider taking a news break.” The latest news action may be included in a remote management configuration. When the latest news action button 424 is selected, the client device 302 may provide an additional user interface for selection of conditions and additional configuration data. The remote management configuration may include additional configuration data including sources of news, selected topics, and preferred news media, among other possible data. In some examples, the latest news action may be associated with a latest news action application. For example, the latest news action application may include an integrated news display that may be included on the client device 302 graphical user interface 306 for reading news.

Another example action may be a randomize action that may be selected with a random suggestion action button 426. The randomize action may be included in a remote management configuration. When the randomize action button 426 is selected, the client device 302 may provide an additional user interface for selection of conditions and additional configuration data. For example, the remote management configuration may include additional configuration data including constraints on random selection of actions or weights to cause particular actions to occur more or less often, among other possible configurations. Upon selection of the randomize action button 426, the client device 302 may provide an indication of the randomize action selection to the virtual conference provider 330. Upon the determination of the occurrence of one or more conditions by the remote management engine 336, the remote management engine 336 may randomly select an action from among the actions corresponding to the conditions that have occurred. In some embodiments, multiple actions may be mapped to one or more conditions. Upon occurrence of the one or more conditions, the randomize action can selection an action from among the multiple actions mapped to the same one or more conditions.

In some examples, the remote management engine 336 may use historical user data to weight the multiple actions mapped to the one or more conditions. For instance, actions with higher weights may be more likely to be randomly selected and actions with lower weights may be less likely to be randomly selected. Other methods of influencing the outcome of the random selection may be used. For example, action selection may be drawn from a probability distribution. The historical data may be representative of previous planned actions. The historical data may include information relating to the completion of previous planned actions. For example, the remote management engine 336 may determine that the user has not completed an exercise planned action on several past occasions and subsequently cause selection of the exercise action by the randomize action to be more likely during subsequent selections.

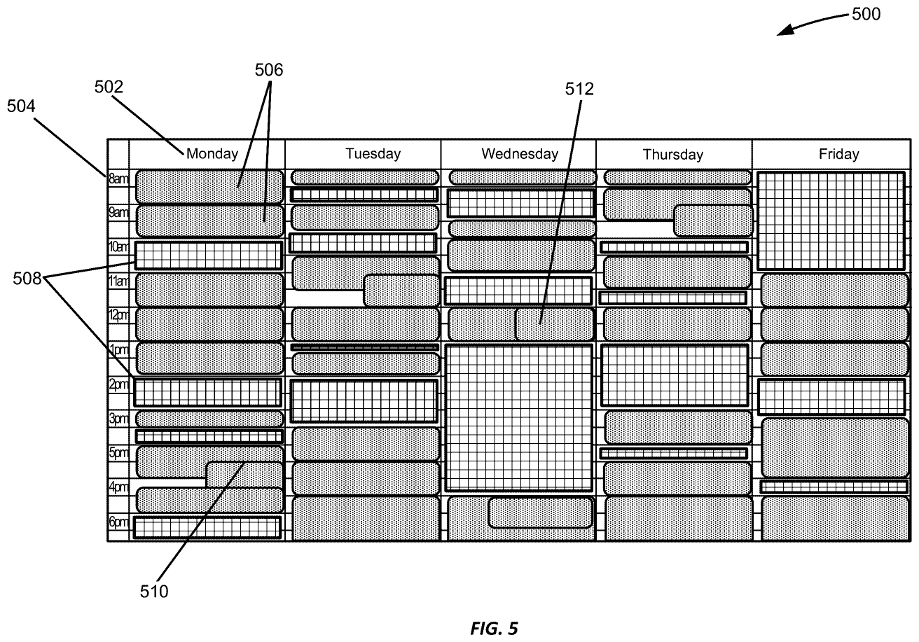

Referring now to FIG. 5, FIG. 5 shows an illustration of an example calendar 500 used by the system 300 for remote management of work-life balance scheduling, according to some aspects of the present disclosure. The example calendar 500 may be provided by a calendar application 312. The example calendar 500 may be displayed on a GUI 306 of a client device 302. Alternatively, the example calendar 500 may be a representation of the data used by the remote management engine 336 for determining a planned action according to remote management configurations upon the occurrence one or more corresponding conditions. In that case, the illustration 500 may be a visualization of data stored in a memory device of a computing device.

The example calendar 500 includes days of the week including, for example, Monday 502. The example calendar 500 includes times of day including, for example, 8 AM 504. However, the example calendar 500 however may use any suitable method for representing and performing operations on dates and times. For example, the remote management engine 336 may use UNIX epoch time internally to determine times and dates, and the client device 302 may convert these to human-readable times and dates as needed for output and display.

The example calendar 500 contains a plurality of events 506. As shown in the example calendar 500, events 506 are shaded rectangles. Events 506 may be scheduled on one or more days and may have a duration. Events 506 may be overlapping 512. For example, more than one event may be scheduled for a particular time and duration. Events may also partially overlap 510, by starting and stopping at different times, but sharing a portion of their respective durations.

The example calendar 500 may contain a plurality of periods 508, or durations between events 506. The remote management engine 336 may identify, based on data received from the client device 302, one or more periods 508 between one or more calendar events. As shown in the example calendar 500, periods 508 are hatched rectangles. The periods 508 are illustrative only and may not appear on a calendar used by the calendar application 312 or visible on the GUI 306. The periods 508 may correspond to the conditions included in the remote management configurations. For example, a remote management configuration may specify that a planned action should be generated for periods longer than 15 minutes. The identification of periods may be made according to additional configuration data included with the remote configuration data. For example, the additional data may specify that periods should be identified only after scheduled events of certain types. A configuration may specify, for instance, that periods should be identified only between video meetings. Periods 508 may extend before the first event of a day or after the last event of the day. For instance, periods 508 may encompass the time between the last event of a day and the first event of the following day. In some examples, the display of events 506 and periods 508 can be toggled using a user interface element that may cause only periods 508 to be displayed. In some examples, periods 508 may be displayed only if a planned event has been scheduled in those periods.

The remote management engine 336 may determine, based on the identified periods 508 and other data and configurations, that one or more conditions corresponding to one or more remote management configurations have been satisfied. The conditions may include data from the example calendar 500 including period duration, previous event start and stop times, following event start and stop times, previous event duration, following event duration, days of the week, time of day, season, month, year, or any other suitable data received from the client device 302 or other sources.

In some examples, the example calendar 500 or other suitable interface may include a work-life balance log (not shown). The work-life balance log may display past and future planned events. The past planned events may include information indicative of the performance or non-performance of planned actions. The work-life balance log may enable the user to track progress on completion of planned actions. For example, some actions may include action applications that include goal-setting features. The work-life balance log may display progress towards completion of those goals using a suitable representation in the user interface including, for example, a visual indication of the percentage completion of the goal.

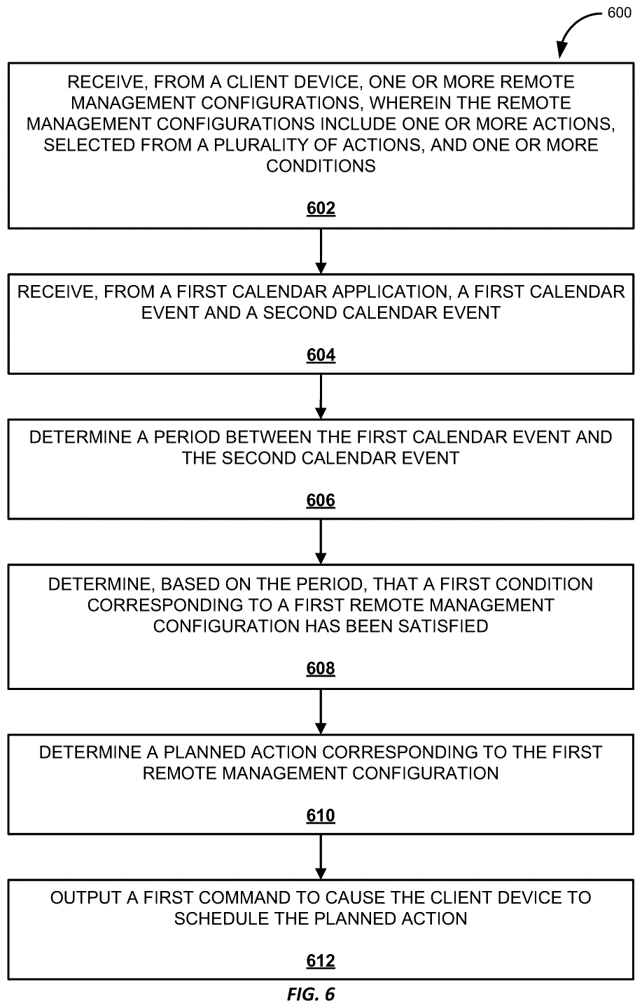

Referring now to FIG. 6, FIG. 6 shows a flowchart of an example method 600 for remote management of work-life balance scheduling. The description of the method 600 in FIG. 6 will be made with reference to FIGS. 3-5, however any suitable system according to this disclosure may be used, such as the example systems 100 and 200, shown in FIGS. 1 and 2.

It should be appreciated that method 600 provides a particular method for remote management of work-life balance scheduling. Other sequences of operations may also be performed according to alternative examples. For example, alternative examples of the present disclosure may perform the steps outlined above in a different order. Moreover, the individual operations illustrated by method 600 may include multiple sub-operations that may be performed in various sequences as appropriate to the individual operation. Furthermore, additional operations may be added or removed depending on the particular applications. Further, the operations described in method 600 may be performed by different devices. For instance, calendar data may be received by the video conference provider 330 or by another client device. One of ordinary skill in the art would recognize many variations, modifications, and alternatives.

The method 600 may include block 602. At block 602, a computing device receives, from a client device, one or more remote management configurations, wherein the remote management configurations include one or more actions, selected from a plurality of actions, and one or more conditions. For example, the video conference provider 330 may receive a remote management configuration from a client device 302. The remote management configuration may be generated by the remote management configuration application 304 upon the selection of one or more actions and one or more corresponding conditions using a GUI displayed on the client device 302, similar to the one depicted in FIG. 5. For example, the user of the client device 302 may select an exercise action with a condition that specifies the action should only be planned during periods of a minimum duration of 30 minutes when the weather is fair and a medication action that includes a condition that specifies the action should only be planned on Thursday between 3 PM and 5 PM. The remote management configuration application 304, upon receiving these selections from the GUI 306, may generate, for example, JSON data containing these remote management configurations and send them to the remote management API module 332 via the I/O module 310.

In some examples, the GUI 306 may include a “chatbot.” A chatbot is a user interface that functions like a chat channel. In some examples, the chatbot may act as a virtual agent or virtual member of a chat channel that can interact with the user. The chatbot can parse user input using a suitable technology, including, for example, natural language processing (NLP) and translate the user input into appropriate configuration data. The user may use the chatbot for creating remote management configurations when remote management of work-life balance scheduling is enabled. For instance, a remote management configuration could be created by providing input like “Chatbot, remind me to exercise if there is any time next week.” Such input would cause a remote management configuration to be created analogous to the one described for the exercise action button 404 in FIG. 4. The chatbot may also generate additional configuration data. For example, the remote management configuration can include data relating to the particular action indicated to the chatbot. Continuing with the previous example, further input could be provided to the chatbot using a phrase like “Make sure exercise is only scheduled if the weather is nice outside.” Such input may result in additional configuration data that specifies that the exercise action should only be planned under certain weather conditions.

At block 604, the computing device receives, from a first calendar application, a first calendar event and a second calendar event. For example, the calendar application 312 of the client device 302 may send a user's calendar or calendar data to the video conference provider 330 via the I/O module 310. The data may be stored in the remote management storage module 338 and/or processed by the remote management engine 336. For example, the calendar data may be converted to a time-series data format suitable for use with an event-based framework. The remote management engine 336 may identify, from among the calendar data, adjacent events in which a first event is followed by a second event. In some examples, the remote management engine 336 may identify events with other relative arrangements. For example, the remote management engine 336 may be configured to identify three consecutive events, wherein each event is greater than a particular duration.

At block 606, the computing device determines a period between the first calendar event and the second calendar event. The period may be defined as the amount of time between the first event and the second event. The period may be an input to one or more conditions associated with one or more actions. For example, the conditions may require the period to begin or end during certain times or time ranges, to be above or below minimum or maximum duration, to fall on certain days of the week, or other requirements. The period may be represented using a data format suitable for iteration over the stored conditions or for use with an event-based framework used by the remote management engine 336.

At block 608, the computing device determines, based on the period, that a first condition corresponding to a first remote management configuration has been satisfied. The remote management engine 336 may iterate over the conditions stored in the remote management storage module 338 or evaluation of a condition may be triggered used the API of an event-based framework. The remote management engine 336 can use the properties of the period (date, day of the week, season, morning/afternoon, start time, end time, etc.) to determine if a condition has been satisfied. For example, the conditions may be represented using an EL or DSL. For instance, a condition involving a period may be “{duration}>15 minutes.” The remote management engine 336 may iterate over all conditions including a “{duration}” field and populate the field with the duration of the period identified in 606. Conditions for which the inequality evaluates to true are identified as satisfied. Conditions may include other data in addition to properties of the period. For example, conditions may include conditions relating to the current geographic location and current weather of the user.

At block 610, the computing device determines a planned action corresponding to the first remote management configuration. When a condition has been satisfied, the remote management engine 336 may query the remote management storage module 338 to determine the planned actions that are associated with the satisfied condition(s). In some cases, more than one action may correspond to the satisfied condition. The computing device may choose the action randomly, according to a pre-configured priority, or according to a specified sequence. In some examples, the user may have selected the randomize action using, for example, the randomize action button 426. In this case, the action will be selected randomly. The selected action is the planned action.

At block 612, the computing device outputs a first command to cause the client device to schedule the planned action. Once the planned action is identified, the computing device may send a message to the client device 302 containing the first command. The first command may be data that causes the scheduling module 314 to schedule the planned action. For example, the message may contain an API call to cause the scheduling module 314 to create a reminder using the reminders module 316 containing text relating to the planned action. Or it may remotely invoke a method for adding a new calendar event using the calendar application 312 containing data about the planned action. The message may contain information including the type of action, which function to use for scheduling, formatted or unformatted text, hyperlinks, references to third-party applications, references to action applications, or other relevant data. The planned event may be scheduled and the goal of the innovations of the present disclosure to balance work and life requirements may thereby be affected.

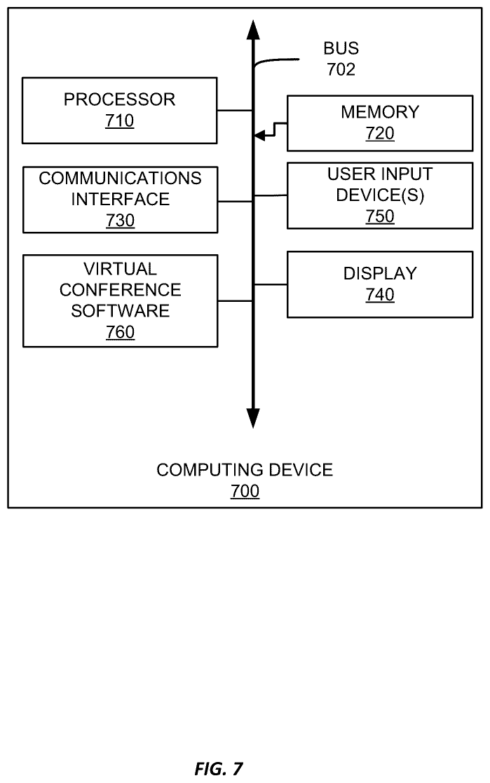

Referring now to FIG. 7, FIG. 7 shows an example computing device 700 suitable for use in example systems or methods for remote management of work-life balance scheduling according to this disclosure. The example computing device 700 includes a processor 710 which is in communication with the memory 720 and other components of the computing device 700 using one or more communications buses 702. The processor 710 is configured to execute processor-executable instructions stored in the memory 720 to perform one or more methods for ad hoc client audio device support for virtual conferences according to different examples, such as part or all of the example method 600 described above with respect to FIG. 6. The computing device 700, in this example, also includes one or more user input devices 750, such as a keyboard, mouse, touchscreen, microphone, etc., to accept user input. The computing device 700 also includes a display 740 to provide visual output to a user.

In addition, the computing device 700 includes virtual conferencing software 760 to enable a user to join and participate in one or more virtual spaces or in one or more conferences, such as a conventional conference or webinar, by receiving multimedia streams from a virtual conference provider, sending multimedia streams to the virtual conference provider, joining and leaving breakout rooms, creating video conference expos, etc., such as described throughout this disclosure, etc.

The computing device 700 also includes a communications interface 730. In some examples, the communications interface 730 may enable communications using one or more networks, including a local area network (“LAN”); wide area network (“WAN”), such as the Internet; metropolitan area network (“MAN”); point-to-point or peer-to-peer connection; etc. Communication with other devices may be accomplished using any suitable networking protocol. For example, one suitable networking protocol may include the Internet Protocol (“IP”), Transmission Control Protocol (“TCP”), User Datagram Protocol (“UDP”), or combinations thereof, such as TCP/IP or UDP/IP.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, that may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification

As used below, any reference to a series of examples is to be understood as a reference to each of those examples disjunctively (e.g., “Examples 1-4” is to be understood as “Examples 1, 2, 3, or 4”).

Example 1 is a computer-implemented method, comprising: receiving, from a client device, one or more remote management configurations, wherein the remote management configurations include one or more actions, selected from a plurality of actions, and one or more conditions; receiving, from a first calendar application, a first calendar event and a second calendar event; determining a period between the first calendar event and the second calendar event; determining, based on the period, that a first condition corresponding to a first remote management configuration has been satisfied; determining a planned action corresponding to the first remote management configuration; and outputting a first command to cause the client device to schedule the planned action.

Example 2 is the method of example(s) 1, further comprising: receiving, from a second calendar application, calendar information.

Example 3 is the method of example(s) 1, further comprising: determining, based on the period and the first calendar event, that the first condition corresponding to the first remote management configuration has been satisfied.

Example 4 is the method of example(s) 1, wherein scheduling the planned action comprises: generating a third calendar event to occur during the period, wherein the third calendar event comprises first action information; and outputting a second command to cause the first calendar application of the client device to schedule the third calendar event.

Example 5 is the method of example(s) 4 wherein the first action information includes a hyperlink to a marketplace application, and further comprising: sending, to the marketplace application, a first indication of the planned action; receiving, from the marketplace application, a second indication of a marketplace selection; and adding, to the first action information, marketplace selection information.

Example 6 is the method of example(s) 1, wherein scheduling the planned action comprises: generating a reminder, wherein the reminder is configured to occur during the period and comprises: second action information; and one or more reminder configurations; and outputting a third command to cause the client device to schedule the reminder.

Example 7 is the method of example(s) 6, further comprising: receiving, from the client device, a reminder configuration update; and outputting a fourth command to cause an update to the one or more reminder configurations.

Example 8 is the method of example(s) 1, wherein the plurality of actions further comprises a randomize action and wherein determining the planned action corresponding to the one or more remote management configurations comprises: receiving, from the client device, the randomize action; determining, based on the period and the first calendar event, that a second condition corresponding to a second remote management configuration has been satisfied; and responsive to the randomize action, selecting the planned action corresponding to a randomly selected action from among the one or more actions.

Example 9 is the method of example(s) 1, further comprising: receiving a third indication that the planned action has begun; and outputting a fifth command comprising instructions to cause an action application associated with the planned action to execute.

Example 10 is a non-transitory computer-readable medium storing a set of instructions, the set of instructions comprising: one or more instructions that, when executed by one or more processors of a device, cause the device to: receive, from a client device, one or more remote management configurations, wherein the remote management configurations include one or more actions, selected from a plurality of actions, and one or more conditions; receive, from a first calendar application, a first calendar event and a second calendar event; determine a period between the first calendar event and the second calendar event; determine, based on the period, that a first condition corresponding to a first remote management configuration has been satisfied; determine a planned action corresponding to the first remote management configuration; and output a first command to cause the client device to schedule the planned action.

The non-transitory computer-readable medium of example(s) 10, further comprising: receiving, from a second calendar application, calendar information.

The non-transitory computer-readable medium of example(s) 10, wherein scheduling the planned action comprises: generating a third calendar event to occur during the period, wherein the third calendar event comprises first action information; and outputting a second command to cause the first calendar application of the client device to schedule the third calendar event.

The non-transitory computer-readable medium of example(s) 12, wherein the first action information includes a hyperlink to a marketplace application, and further comprising: sending, to the marketplace application, a first indication of the planned action receiving, from the marketplace application, a second indication of a marketplace selection; and adding, to the first action information, marketplace selection information.

The non-transitory computer-readable medium of example(s) 10, wherein scheduling the planned action comprises: generating a reminder, wherein the reminder is configured to occur during the period and comprises: second action information; and one or more reminder configurations; and outputting a third command to cause the client device to schedule the reminder.

The non-transitory computer-readable medium of example(s) 10, further comprising: receiving a third indication that the planned action has begun; and outputting a fifth command comprising instructions to cause an action application associated with the planned action to execute.

Example 16 is a system comprising: one or more processors configured to: receive, from a client device, one or more remote management configurations, wherein the remote management configurations include one or more actions, selected from a plurality of actions, and one or more conditions; receive, from a first calendar application, a first calendar event and a second calendar event; determine a period between the first calendar event and the second calendar event; determine, based on the period, that a first condition corresponding to a first remote management configuration has been satisfied; determine a planned action corresponding to the first remote management configuration; and output a first command to cause the client device to schedule the planned action.

The system of example(s) 16, further comprising: receiving, from a second calendar application, calendar information.

The system of example(s) 16, wherein scheduling the planned action comprises: generating a third calendar event to occur during the period, wherein the third calendar event comprises first action information; and outputting a second command to cause the first calendar application of the client device to schedule the third calendar event.

The system of example(s) 16, wherein scheduling the planned action comprises: generating a reminder, wherein the reminder is configured to occur during the period and comprises: second action information; and one or more reminder configurations; and outputting a third command to cause the client device to schedule the reminder.

The system of example(s) 16, further comprising: receiving a third indication that the planned action has begun; and outputting a fifth command comprising instructions to cause an action application associated with the planned action to execute.

That which is claimed is:

1. A computer-implemented method, comprising:
receiving, from a client device, one or more remote management configurations, wherein the remote management configurations include one or more actions, selected from a plurality of actions, and one or more conditions;
receiving, from a first calendar application, a first calendar event and a second calendar event;
determining a period between the first calendar event and the second calendar event;
determining, based on the period, that a first condition corresponding to a first remote management configuration has been satisfied;
determining a planned action corresponding to the first remote management configuration; and
outputting a first command to cause the client device to schedule the planned action.

2. The method of claim 1, further comprising:
receiving, from a second calendar application, calendar information.

3. The method of claim 1, further comprising:
determining, based on the period and the first calendar event, that the first condition corresponding to the first remote management configuration has been satisfied.

4. The method of claim 1, wherein scheduling the planned action comprises:
generating a third calendar event to occur during the period, wherein the third calendar event comprises first action information; and
outputting a second command to cause the first calendar application of the client device to schedule the third calendar event.

5. The method of claim 4 wherein the first action information includes a hyperlink to a marketplace application, and further comprising:
sending, to the marketplace application, a first indication of the planned action;
receiving, from the marketplace application, a second indication of a marketplace selection; and
adding, to the first action information, marketplace selection information.

6. The method of claim 1, wherein scheduling the planned action comprises:
generating a reminder, wherein the reminder is configured to occur during the period and comprises:
second action information; and
one or more reminder configurations; and
outputting a third command to cause the client device to schedule the reminder.

7. The method of claim 6, further comprising:
receiving, from the client device, a reminder configuration update; and
outputting a fourth command to cause an update to the one or more reminder configurations.

8. The method of claim 1, wherein the plurality of actions further comprises a randomize action and wherein determining the planned action corresponding to the one or more remote management configurations comprises:
receiving, from the client device, the randomize action;
determining, based on the period and the first calendar event, that a second condition corresponding to a second remote management configuration has been satisfied; and
responsive to the randomize action, selecting the planned action corresponding to a randomly selected action from among the one or more actions.

9. The method of claim 1, further comprising:
receiving a third indication that the planned action has begun; and
outputting a fifth command comprising instructions to cause an action application associated with the planned action to execute.

10. A non-transitory computer-readable medium storing a set of instructions, the set of instructions comprising:
one or more instructions that, when executed by one or more processors of a device, cause the device to:
receive, from a client device, one or more remote management configurations, wherein the remote management configurations include one or more actions, selected from a plurality of actions, and one or more conditions;
receive, from a first calendar application, a first calendar event and a second calendar event;
determine a period between the first calendar event and the second calendar event;
determine, based on the period, that a first condition corresponding to a first remote management configuration has been satisfied;
determine a planned action corresponding to the first remote management configuration; and
output a first command to cause the client device to schedule the planned action.

11. The non-transitory computer-readable medium of claim 10, further comprising:
receiving, from a second calendar application, calendar information.

12. The non-transitory computer-readable medium of claim 10, wherein scheduling the planned action comprises:
generating a third calendar event to occur during the period, wherein the third calendar event comprises first action information; and
outputting a second command to cause the first calendar application of the client device to schedule the third calendar event.

13. The non-transitory computer-readable medium of claim 12, wherein the first action information includes a hyperlink to a marketplace application, and further comprising:
sending, to the marketplace application, a first indication of the planned action
receiving, from the marketplace application, a second indication of a marketplace selection; and
adding, to the first action information, marketplace selection information.

14. The non-transitory computer-readable medium of claim 10, wherein scheduling the planned action comprises:
generating a reminder, wherein the reminder is configured to occur during the period and comprises:
second action information; and
one or more reminder configurations; and
outputting a third command to cause the client device to schedule the reminder.

15. The non-transitory computer-readable medium of claim 10, further comprising:
receiving a third indication that the planned action has begun; and
outputting a fifth command comprising instructions to cause an action application associated with the planned action to execute.

16. A system comprising:
one or more processors configured to:
receive, from a client device, one or more remote management configurations, wherein the remote management configurations include one or more actions, selected from a plurality of actions, and one or more conditions;
receive, from a first calendar application, a first calendar event and a second calendar event;
determine a period between the first calendar event and the second calendar event;
determine, based on the period, that a first condition corresponding to a first remote management configuration has been satisfied;
determine a planned action corresponding to the first remote management configuration; and
output a first command to cause the client device to schedule the planned action.

17. The system of claim 16, further comprising:
receiving, from a second calendar application, calendar information.

18. The system of claim 16, wherein scheduling the planned action comprises:
generating a third calendar event to occur during the period, wherein the third calendar event comprises first action information; and
outputting a second command to cause the first calendar application of the client device to schedule the third calendar event.

19. The system of claim 16, wherein scheduling the planned action comprises:
generating a reminder, wherein the reminder is configured to occur during the period and comprises:
second action information; and
one or more reminder configurations; and
outputting a third command to cause the client device to schedule the reminder.

20. The system of claim 16, further comprising:
receiving a third indication that the planned action has begun; and
outputting a fifth command comprising instructions to cause an action application associated with the planned action to execute.
